(19) United States
(12) Patent Application Publication
(10) Pub. No.: US 2023/0203252 A1
(43) Pub. Date: Jun. 29, 2023

(54) SILICONE RUBBER COMPOSITION AND WOVEN MATERIAL COATED WITH SILICONE RUBBER

(71) Applicant: DOW TORAY CO., LTD., Shinagawa-ku,Tokyo (JP)

(72) Inventors: Tomoko TASAKI, Ichihara-shi, Chiba (JP); Yuji SAITO, Ichihara-shi, Chiba (JP)

(21) Appl. No.: 17/921,469

(22) PCT Filed: Apr. 27, 2021
(86) PCT No.: PCT/JP2021/016823

§ 371 Date: Oct. 26, 2022

(30) Foreign Application Priority Data
Apr. 30, 2020 (JP) 2020-080657

(51) Int. Cl. C08G 77/20; C08G 77/12; C08G 77/08; C08K 3/36; C08K 5/521; C08K 5/098; C08K 5/5435; C08K 3/22; D06M 15/643; B60R 21/235

(52) U.S. Cl. CPC C08G 77/20; C08G 77/12; C08G 77/08; C08K 3/36; C08K 5/521; C08K 5/098; C08K 5/5435; C08K 3/22; D06M 15/643; B60R 21/235; C08K 2003/2217; C08K 2003/2227; B60R 2021/23514

(57) ABSTRACT

A silicone rubber composition is provided. The composition comprises: (A) a straight chain organopolysiloxane having at least two alkenyl groups in a molecule; (B) a resinous organopolysiloxane containing: SiO_{4/2} unit, R¹₂R²SiO_{1/2} unit and R¹₃SiO_{1/2} unit, wherein R¹ independently represents an alkyl group having 1 to 12 carbon atoms and R² represents an alkenyl group having 2 to 12 carbon atoms, and containing 0.1 to 5.0 mass % of the alkenyl groups; (C) an organopolysiloxane having at least two silicon atom-bonded hydrogen atoms in a molecule; (D) a hydrosilylation reaction catalyst; (E) a reinforcing silica fine powder; and (F) an intumescent flame retardant. When the composition is coated on a woven material, such as a base material for an airbag or the like, the composition can provide the woven material with sufficient flame retardance even with a low coating amount, and the composition can suppress an aperture of the woven material.

### TECHNICAL FIELD

The present invention relates to a silicone rubber composition and a woven material coated with a silicone rubber using the composition.

### BACKGROUND ART

Woven materials coated with a silicone rubber where a silicone rubber composition is coated on a woven material such as a base material for an airbag or the like are used in airbags for a vehicle or the like. In recent years, in order to compactly store an airbag, reducing a coating amount of the silicone rubber composition is being considered, and improving flame retardance of the woven material coated with a silicone rubber is also being considered.

In order to improve flame retardance of silicone rubber, for example, Patent Document 1 proposes that a flame retardant additive that contains a gas generating agent selected from a group consisting of compounds containing both phosphorus and nitrogen, or a gas generating agent that is a mixture of a phosphorus-containing compound and a nitrogen-containing compound, and a silicone resin containing as primary components M units represented by the formula: R₃SiO_{1/2}, wherein R represents a homologous or heterologous group selected from unsubstituted or substituted hydrocarbon groups having 1 to 30 carbon atoms, and Q units represented by the formula: SiO_{4/2}, may be added to a rubber composition such as a sealant for construction, LIMS, or the like. Patent Document 2 proposes a liquid silicone rubber composition for coating on a woven material, wherein the composition contains a reinforcing silica fine powder and an aluminum hydroxide, and does not contain a solvent and a resinous organopolysiloxane. Patent Document 3 proposes that an organic phosphazene compound is further added to a liquid silicone rubber composition for a curtain airbag containing an organopolysiloxane resin and a silica fine powder. Furthermore, Patent Document 4 proposes a silicone rubber composition containing a fumed silica, a triazole compound and a phosphate ester compound.

However, with these silicone rubber compositions, there are problems where the coating amount of the silicone rubber composition is difficult to reduce, the flame retardance of a woven material coated with the silicone rubber is not sufficient, or both cannot be satisfied.

### CITATION LIST

### Patent Literature

[Patent Document 1] Japanese Unexamined Patent Application Publication No. 2005-226034

[Patent Document 2] Japanese Unexamined Patent Application Publication No. 2010-053493

[Patent Document 3] Japanese Unexamined Patent Application Publication No. 2014-136722

[Patent Document 4] Japanese Unexamined Patent Application Publication No. 2016-094514

### SUMMARY OF INVENTION

### Technical Problem

An object of the present invention is to provide a silicone rubber composition that can provide a woven material such as a base material for an airbag or the like with sufficient flame retardance even with a low coating amount, when the composition is coated on the woven, and it can suppress an aperture of the woven. Furthermore, another object of the present invention is to provide a woven material coated with a silicone rubber with excellent flame retardance, and its aperture is suppressed even when a large tension is applied

### Solution to Problem

The silicone rubber composition of the present invention comprises:
(A) 100 parts by mass of a straight chain organopolysiloxane having at least two alkenyl groups in a molecule;
(B) 5 to 100 parts by mass of a resinous organopolysiloxane containing: SiO_{4/2} unit, R¹₂R²SiO_{1/2} unit and R¹₃SiO_{1/2} unit, wherein R¹ independently represents an alkyl group having 1 to 12 carbon atoms and R² represents an alkenyl group having 2 to 12 carbon atoms, and containing 0.1 to 5.0 mass % of the alkenyl groups;
(C) an organopolysiloxane having at least two silicon atom-bonded hydrogen atoms in a molecule, in an amount such that the silicon atom-bonded hydrogen atoms in this component are 0.5 to 10 mols per 1 mol of the alkenyl groups in components (A) and (B);
(D) a hydrosilylation reaction catalyst in an amount to promote curing of the present composition;
(E) 0.1 to 50 parts by mass of a reinforcing silica fine powder; and
(F) 5 to 30 parts by mass of an intumescent flame retardant.

In various embodiments, the present composition further comprises: (G) an organic titanium compound and/or an organic zirconium compound, in an amount of 0.01 to 10 parts by mass per 100 parts by mass of component (A); (H) an alkoxysilane containing an epoxy group and/or an alkoxysilane containing a methacrylic group or an acrylic group, in an amount of 0.01 to 10 parts by mass per 100 parts by mass of component (A); (I) a silanol group-containing organosiloxane oligomer, in an amount of 0.01 to 10 parts by mass per 100 parts by mass of component (A); (J) an organic aluminum compound, in an amount of 0.01 to 10 parts by mass per 100 parts by mass of component (A); or (K) an aluminum hydroxide powder, in an amount of 5 to 50 parts by mass per 100 parts by mass of component (A). In various embodiments, the present composition is a silicone rubber composition for coating a woven material.

Next, the woven material coated with a silicone rubber of the present invention is obtained by coating the silicone rubber composition of the present invention onto a surface of a woven material, and then curing the composition. In various embodiments, the woven material is a base material for an airbag.

### Effect of Invention

The silicone rubber composition of the present invention can provide a woven material such as a base material for an airbag or the like with sufficient flame retardance even with a low coating amount, when the composition is coated on the woven, and it can suppress an aperture of the woven. Furthermore, the woven material coated with a silicone rubber of the present invention has excellent flame retardance, and its aperture is suppressed even when a large tension is applied.

### DETAILED DESCRIPTION OF THE INVENTION

<Silicone Rubber Composition>

Component (A) is a straight chain organopolysiloxane serving as a main agent of the present composition and having at least two alkenyl groups in a molecule. Examples of the alkenyl groups in component (A) include vinyl groups, allyl groups, butenyl groups, pentenyl groups, hexenyl groups, heptenyl groups, octenyl groups, nonenyl groups, decenyl groups, and other alkenyl groups having 2 to 12 carbon atoms. However, vinyl groups are preferred. Furthermore, examples of groups bonded to silicon atoms other than the alkenyl groups in component (A) include: methyl groups, ethyl groups, propyl groups, butyl groups, pentyl groups, hexyl groups, heptyl groups, and other alkyl groups having 1 to 12 carbon atoms; phenyl groups, tolyl groups, xylyl groups, and other aryl groups having 6 to 12 carbon atoms; benzyl groups, phenethyl groups, and other aralkyl groups having 7 to 12 carbon atoms; and 3-chloropropyl groups, 3,3,3-trifluoropropyl groups, and other alkyl halide groups having 1 to 12 carbon atoms. Methyl groups and phenyl groups are preferred. Furthermore, a small amount of hydroxyl groups; or methoxy groups, ethoxy groups, or other alkoxy groups may be bonded to the silicon atom in component (A) within a scope that does not impair an object of the present invention.

A molecular structure of component (A) is essentially a straight chain, but a portion of the molecular chain may be slightly branched. Furthermore, a viscosity of component (A) is not limited, but the viscosity at 25° C. is preferably within a range of 100 to 100,000 mPa·s, alternatively within a range of 1,000 to 50,000 mPa·s. This is because, when the viscosity of component (A) is above the lower limit of the aforementioned range, a mechanical strength of the silicone rubber is enhanced, but when the viscosity is below the upper limit of the range, a coatability of the silicone rubber composition improves. Note that the viscosity of component (A) can be measured by a rotational viscometer in accordance with JIS K7117-1.

Examples of the organopolysiloxanes for component (A) include a dimethylpolysiloxane end-blocked with dimethylvinylsiloxy groups at both molecular chain terminals, a copolymer of dimethylsiloxane and methylvinylsiloxane endblocked with dimethylvinylsiloxy groups at both molecular chain terminals, a copolymer of dimethylsiloxane and methylphenylsiloxane end-blocked with dimethylvinylsiloxy groups at both molecular chain terminals, and a copolymer of methyl(3,3,3-trifluoropropyl)siloxane and methylvinylsiloxane end-blocked with dimethylvinylsiloxy groups at both molecular chain terminals.

Component (B) is a resinous organopolysiloxane for improving the mechanical strength of silicone rubber, and contains a siloxane of Q unit represented by the formula: SiO_{4/2} unit and siloxanes of M units represented by the formula: R¹₂R²SiO_{1/2} unit and the formula: R¹₃SiO_{1/2} unit. In the formulae, R¹ independently represents an alkyl group having 1 to 12 carbon atoms, and specific examples include methyl groups, ethyl groups, propyl groups, butyl groups, pentyl groups, hexyl groups, and heptyl groups, but methyl groups are preferred. Furthermore, in the formulae, R² represents an alkenyl group having 2 to 12 carbon atoms, and specific examples include vinyl groups, allyl groups, butenyl groups, pentenyl groups, hexenyl groups, heptenyl groups, octenyl groups, nonenyl groups, and decenyl groups, but vinyl groups are preferred. Component (B) contains 0.1 to 5.0 mass % of the alkenyl groups, preferably contains 0.5 to 5.0 mass %, alternatively 0.5 to 2.5 mass % of the alkenyl group. Note that component (B) may contain another siloxane unit, for example, a siloxane of D unit represented by the formula: R¹₂SiO_{2/2} or a siloxane of T unit represented by the formula: R¹SiO_{3/2}, within a scope that does not impair an object of the present invention. Note that Win the formulae are the same as described above.

Examples of the resinous organopolysiloxanes for component (B) include resins containing: SiO_{4/2} unit, (CH₃)₃SiO_{1/2} unit and (CH₂═CH)(CH₃)₂SiO_{1/2} unit, resins containing: SiO_{4/2} unit, (CH₃)₃SiO_{1/2} unit, (CH₂═CH)(CH₃)₂SiO_{1/2} unit and (CH₃)₂SiO_{2/2} unit, resins containing: SiO_{4/2} unit, C₆H₅(CH₃)₂SiO_{1/2} unit and (CH₂═CH)(CH₃)₂SiO_{1/2} unit, and resins containing: SiO_{4/2} unit, (CH₃)₃SiO_{1/2} unit, (CH₂═CH)(CH₃)₂SiO_{1/2} unit and CH₃SiO_{3/2} unit. Furthermore, those which are liquid at ambient temperature or those having compatibility with component (A) even as a solid are preferred.

A content of component (B) is within a range of 5 to 100 parts by mass, and preferably within a range of 10 to 80 parts by mass, with respect to 100 parts by mass of component (A). This is because, when the content of component (B) is not less than the lower limit of the aforementioned range, the mechanical strength of the silicone rubber improves, and when the content is not more than the upper limit of the range, the viscosity of the silicone rubber composition is relatively low and coating onto a base material without a solvent is possible.

Component (C) is an organopolysiloxane serving as a crosslinking agent of the present composition and having at least two silicon atom-bonded hydrogen atoms in a molecule. Examples of silicon atom-bonded organic groups other than hydrogen atoms in component (C) include: methyl groups, ethyl groups, propyl groups, and other alkyl groups having 1 to 12 carbon atoms; phenyl groups, tolyl groups, xylyl groups, and other aryl groups having 6 to 12 carbon atoms; 3-chloropropyl groups, 3,3,3-trifluoropropyl groups, and other alkyl halide groups having 1 to 12 carbon atoms, but methyl groups and phenyl groups are preferred.

A molecular structure of component (C) is not limited, but examples include straight chain structures, branched chain structures, partially branched straight chain structures, cyclic structures, and resin structures. Furthermore, a viscosity of component (C) is not limited, but its kinematic viscosity at 25° C. is preferably within a range of 1 to 1,000 mm²/s, alternatively within a range of 1 to 100 mm²/s. This is because, when the viscosity of component (C) is not less than the lower limit of the aforementioned range, the mechanical strength of the silicone rubber improves, and when it is not more than the upper limit of the range, the coatability of the silicone rubber composition improves. Note that the viscosity of component (C) can be measured by an Ubbelohde viscometer in accordance with JIS Z8803.

Examples of the organopolysiloxanes for component (C) include a methylhydrogenpolysiloxane end-blocked with trimethylsiloxy groups at both molecular chain terminals, a copolymer of dimethylsiloxane and methylhydrogensiloxane end-blocked with trimethylsiloxy groups at both molecular chain terminals, a copolymer of methylphenylsiloxane and methylhydrogensiloxane end-blocked with dimethylphenylsiloxy groups at both molecular chain terminals, a cyclic methylhydrogenpolysiloxane, a copolymer of a dimethylhydrogensiloxy unit and SiO_{4/2} unit.

A content of component (C) is an amount such that the silicon atom-bonded hydrogen atoms in this organopolysiloxane are in a range of from 0.5 to 10 mols, preferably in a range of from 0.8 to 10 mols, alternatively in a range of from 1 to 10 mols, or alternatively in a range of from 1 to 5 mols, with regard to 1 mole of a total alkenyl groups in components (A) and (B). This is because, when the content of component (C) is not less than the lower limit of the aforementioned range, the silicone rubber composition is sufficiently cured, and when the content is not more than the upper limit of the aforementioned range, heat resistance of the silicone rubber improves.

Component (D) is a hydrosilylation reaction catalyst to promote curing of the present composition. Examples of the catalysts for component (D) include platinum-based catalysts, rhodium-based catalysts, ruthenium-based catalysts, iridium-based catalysts, palladium-based catalysts, and other platinum group metal-based catalysts. Platinum-based catalysts are preferred. Examples of the platinum-based catalysts include: platinum fine powders, chloroplatinic acids, alcoholic solutions of a chloroplatinic acid, olefin complexes of a chloroplatinic acid, alkenylsiloxane complexes of a chloroplatinic acid, platinum diketone complexes, platinum alkenylsiloxane complexes, and platinum olefin complexes; other metal platinum supported on silica, alumina, carbon, or the like; and thermoplastic resin powder containing the platinum-based catalysts.

A content of component (D) is a catalytic amount, and is an amount such that a catalytic metal in component (D) is normally within a range of 0.1 to 500 parts by mass, and preferably within a range of 1 to 50 parts by mass, with regard to 1,000,000 parts by mass of component (A). This is because, when the content is less than 0.1 parts by mass, the reaction does not sufficiently proceed, and when it is more than 500 parts by mass, the economics are not favorable.

Component (E) is a reinforcing silica fine powder for providing mechanical strength to the silicone rubber obtained by curing the present composition. Examples of component (E) include dry method silica, precipitation method silica, and hydrophobic silica where a surface of the reinforcing silica fine powder is treated with organochlorosilanes, organosilazanes, organoalkoxysilanes, organohydrogenpolysiloxanes, or other organic silicon compounds. Component (E) particularly preferably has a specific surface area of 50 m²/g or more.

A content of component (E) is within a range of 0.1 to 50 parts by mass, and preferably within a range of 5 to 40 parts by mass, alternatively within a range of 5 to 30 parts by mass, with regard to 100 parts by mass of component (A). This is because, when the content of component (E) is not less than the lower limit of the aforementioned range, the mechanical strength of the silicone rubber is excellent, and when it is not more than the upper limit of the range, the coatability of the silicone rubber composition is favorable.

Component (F) is an intumescent flame retardant for improving flame retardance of silicone rubber, and is a mixture containing at least one type of melamine salt selected from a group consisting of melamine orthophosphates, melamine pyrophosphates and melamine polyphosphates; and at least one piperazine salt selected from a group consisting of piperazine orthophosphates, piperazine pyrophosphates and piperazine polyphosphates; and optionally containing a hydrotalcite compound or a cyclodextrin. The ratio of the melamine salt to the piperazine salt is not limited, but the mass ratio thereof is preferably within a range of 20:80 to 50:50. Furthermore, when the hydrotalcite compound is included, 0.01 to 5 parts by mass of the hydrotalcite compound is preferably included with regard to 100 parts by mass of a total of the melamine salt and the piperazine salt. Examples of available intumescent flame retardants include a non-halogen intumescent flame retardant (ADK STAB FP-2100JC manufactured by ADEKA Corporation) and a non-halogen intumescent flame retardant (ADK STAB FP-25005 manufactured by ADEKA Corporation). In the present invention, adding a well-known intumescent flame retardant as a flame retardant of an organic resin in the silicone rubber composition, and particularly the silicone rubber composition containing the resinous organopolysiloxane for component (B) and a reinforcing silica fine powder for component (E) was discovered to provide significant flame retardance to a woven material coated with a silicone rubber even with a low coating amount of the silicone rubber composition.

A content of component (F) is within a range of 5 to 30 parts by mass, and preferably within a range of 10 to 30 parts by mass, alternatively within a range of 15 to 30 parts by mass, with regard to 100 parts by mass of component (A). This is because, when the content of component (F) is not less than the lower limit of the aforementioned range, the flame retardance of the woven material coated with a silicone rubber improves, and when it is not more than the upper limit of the range, the coatability of the silicone rubber composition improves.

The present composition may comprise: (G) an organic titanium compound and/or an organic zirconium compound in order to maintain adhesive properties of the silicone rubber to the woven material even after the woven material coated with a silicone rubber obtained by coating and curing the composition is stored over a long period of time under conditions of high temperature and high humidity.

Examples of the organic titanium compounds for component (G) include: tetraisopropyltitanate, tetrabutyltitanate, tetraoctyltitanate, and other organic titanate esters; titanium acetate and other organic acid titanium salts; diisopropoxy bis(acetylacetonate) titanium, diisopropoxy bis(ethylacetate) titanium, and other titanium chelate compounds.

Furthermore, examples of the organic zirconium compounds for component (G) include zirconium tetraacetylacetonate, zirconium hexafluoroacetylacetonate, zirconium trifluoroacetylacetonate, tetrakis(ethyltrifluoroacetylacetonate) zirconium, tetrakis(2,2,6,6-tetramethyl-heptanedionate), zirconium dibutoxy bis(ethylacetoacetate), diisopropoxy bis(2,2,6,6-tetramethyl-heptanedionate) zirconium, and other zirconium complexes having a β-diketone (including alkyl group substitution products and fluorine atom substitution products) as a ligand. The organic zirconium compound is particularly preferably an acetylacetonate complex of zirconium (including alkyl group substitution products and fluorine atom substitution products of an acetylacetonate).

In the present composition, a content of component (G) is within a range of 0.01 to 10 parts by mass, and preferably within a range of 0.1 to 5 part by mass, alternatively within a range of 0.5 to 5 parts by mass, with regard to 100 parts by mass of component (A). This is because, when the content of component (G) is not less than the lower limit of the aforementioned range, favorable adhesive properties can be maintained even to a poorly adhesive adherend such as a woven material, and when it is not more than the upper limit of the range, the storage stability of the silicone rubber composition improves.

Furthermore, the present composition may comprise: (H) an alkoxysilane containing an epoxy group and/or an alkoxysilane containing a methacrylic group or an acrylic group for improving favorable adhesive properties to a poorly adhesive adherend such as a woven material.

Examples of the alkoxysilanes containing an epoxy group for component (H) include 3-glycidoxypropyl trimethoxysilane, 3-glycidoxypropyl triethoxysilane, 3-glycidoxypropylmethyl dimethoxysilane, 4-glycidoxybutyl trimethoxysilane, 5,6-epoxyhexyl triethoxysilane, 2-(3,4-epoxycyclohexyl)ethyl trimethoxysilane, and 2-(3,4-epoxycyclohexyl)ethyl triethoxysilane.

Furthermore, examples of the alkoxysilanes containing a methacrylic group or an acrylic group for component (H) include 3-acryloxypropyl trimethoxysilane, 3-acryloxypropyl triethoxysilane, 3-acryloxypropylmethyl dimethoxysilane, 3-methacryloxypropyl trimethoxysilane, 3-methacryloxypropyl triethoxysilane, and 3-methacryloxypropylmethyl dimethoxysilane.

In the present composition, a content of component (H) is within a range of 0.01 to 10 parts by mass, and preferably within a range of 0.1 to 5 parts by mass, alternatively within a range of 0.5 to 5 parts by mass, with regard to 100 parts by mass of component (A). This is because, when the content of component (H) is not less than the lower limit of the aforementioned range, favorable adhesive properties can be maintained even to a poorly adhesive adherend such as a woven material, and when it is not more than the upper limit of the range, the storage stability of the silicone rubber composition improves.

The present composition preferably further comprises: (I) a silanol group-containing organosiloxane oligomer. Examples of groups bonded to silicon atoms in component (I) include: methyl groups, ethyl groups, propyl groups, butyl groups, pentyl groups, hexyl groups, and other alkyl groups; vinyl groups, allyl groups, butenyl groups, pentenyl groups, hexenyl groups, heptenyl groups, and other alkenyl groups; phenyl groups, tolyl groups, xylyl groups, and other aryl groups; benzyl groups, phenethyl groups, and other aralkyl groups; 3-chloropropyl groups, 3,3,3,3,3-trifluoropropyl groups, and other alkyl halide groups. Methyl groups and vinyl groups are preferred. A molecular structure of component (I) is not limited, but examples include straight chain structures, partially branched straight chain structures, cyclic structures, and branched structures. Straight chain structures are preferred. Furthermore, a viscosity of component (I) at 25° C. is not limited, but is preferably less than 100 mPa·s, alternatively within a range of 1 to 50 mPa·s.

Examples of component (I) include a methylvinylpolysiloxane end-blocked with dimethylhydroxysiloxy groups at both molecular chain terminals and a copolymer of dimethylsiloxane and methylvinylsiloxane end-blocked with dimethylhydroxysiloxy groups at both molecular chain terminals.

In the present composition, a content of component (I) is not limited, but is within a range of 0.01 to 10 parts by mass, and preferably within a range of 0.1 to 5 parts by mass, alternatively within a range of 0.5 to 5 parts by mass, with regard to 100 parts by mass of component (A). This is because, when the content of component (I) is not less than the lower limit of the aforementioned range, favorable adhesive properties can be maintained even to a poorly adhesive adherend such as a woven material, and when it is not more than the upper limit of the range, the storage stability of the silicone rubber composition improves.

Furthermore, the present composition preferably comprises: (J) an organic aluminum compound because flame retardance can be improved even if the content of component (F) is reduced. Examples of component (J) include aluminum tris(acetylacetonate), aluminum tris(ethylacetate), ethylacetoacetate aluminum diisopropylate, aluminum tris(ethylacetoacetate), alkylacetoacetate aluminum isopropylate, aluminum monoacetylacetate bis(ethylacetoacetate), aluminum monoisopropoxy monooleoxy ethylacetoacetate, aluminum-di-n-butoxide monoethylacetoacetate, aluminumdi-iso-propoxide monoethylacetoacetate, aluminum isopropylate, monosec-butoxyaluminum diisopropylate, aluminum-sec-butyrate, and aluminum ethylate.

In the present composition, a content of component (J) is not limited, but is within a range of 0.01 to 10 parts by mass, and preferably within a range of 0.1 to 5 parts by mass, alternatively within a range of 0.5 to 5 parts by mass, with regard to 100 parts by mass of component (A). This is because, when the content of component (J) is not less than the lower limit of the aforementioned range, a flame retarding function of component (F) can be improved, and when it is not more than the upper limit of the range, the storage stability of the silicone rubber composition improves.

Furthermore, the present composition preferably comprises: (K) an aluminum hydroxide powder because flame retardance can be improved even if the content of component (F) is reduced. A particle size of component (K) is not particularly limited. For example, the average particle size is preferably within a range of 0.1 to 50 μm, alternatively within a range of 0.1 to 10 μm. A shape thereof is also not limited, and examples include spherical shapes, essentially spherical shapes, and crushed shapes. Examples of component (K) include available aluminum hydroxide powders with an average particle size of 1.0 μm (Product name: Hidilite H42M manufactured by Showa Denko K.K.) and aluminum hydroxide with an average particle size of 1.0 μm surface treated with a silane coupling agent (Hidilite H42STV manufactured by Showa Denko K.K.).

In the present composition, a content of component (K) is not limited, but is within a range of 5 to 50 parts by mass, and preferably within a range of 10 to 50 parts by mass, alternatively within a range of 10 to 30 parts by mass, with regard to 100 parts by mass of component (A). This is because, when the content of component (J) is not less than the lower limit of the aforementioned range, a flame retarding function of component (F) can be improved, and an aperture can be further suppressed. Furthermore, when it is not more than the upper limit of the range, the coatability of the silicone rubber composition improves.

Furthermore, the present composition preferably comprises: a curing inhibitor in order to improve storage stability and handling workability. Examples of the curing inhibitor include: 1-ethynylcyclohexan-1-ol, 2-methyl-3-butyn-2-ol, 3,5-dimethyl-l-hexyn-3-ol, 2-phenyl-3-butyn-2-ol, and other acetylene compounds; 3-methyl-3-penten-1-yne, 3,5-dimethyl-3-hexen-1-yne, and other enyne compounds; benzotrizole and other triazoles; and phosphines, mercaptans, and hydrazines. A content of the curing inhibitor is not limited, but is preferably within a range of 0.001 to 10 parts by mass, alternatively within a range of 0.01 to 10 parts by mass, with regard to 100 parts by mass of component (A).

Furthermore, the present composition may comprise: an inorganic filler other than components (E) and (K) within a scope that does not impair an object of the present invention. Examples of the inorganic filler include: quartz powder, diatomaceous earth, calcium carbonate, magnesium carbonate, and other extender fillers; cerium oxide, cerium hydroxide, iron oxide, and other heat resistance agents; red iron oxide, titanium oxide, carbon black, and other pigments; and flame retardants.

A method of preparing the present composition is not limited, and the composition can be prepared by mixing components (A) to (F) and, if necessary, another optional component. However, a silica masterbatch prepared by heating and mixing component (E) and a portion of component (A) in advance is preferably mixed with the remaining component (A), component (B), component (C), component (D), and component (F). Note that if another optional component must be added, the present component may be added when preparing the silica masterbatch. Furthermore, if the present component changes due to heating and mixing, the present component is preferably added when adding the remaining component (A), component (B), component (C), component (D), and component (F). Furthermore, when preparing the silica masterbatch, the organic silicon compound may be added to treat the surface of compound (E) in-situ. When preparing the present composition, a well-known kneading device such as two rollers, a kneader mixer, a Ross mixer, or the like can be used.

<Woven Material Coated with Silicone Rubber>

The woven material coated with a silicone rubber of the present invention is obtained by coating the silicone rubber composition described above onto a surface of a woven material and then curing the composition. Examples of the woven material used as the present woven material include: nylon 6, nylon 66, nylon 46, and other polyamide fiber woven materials; polyethylene terephthalate, polybutylene terephthalate, polytrimethylene terephthalate, and other polyester fiber woven materials; and polyacrylic fiber woven materials, polyacrylonitrile fiber woven materials, aramid fiber woven materials, polyetherimide fiber woven materials, polysulfone fiber woven materials, carbon fiber woven materials, rayon fiber woven materials, polypropylene fiber woven materials, polyethylene fiber woven materials, and nonwoven materials containing these fibers. Polyamide fiber woven materials and polyester fiber woven materials are particularly preferable as an airbag base material from the perspective of excellent heat resistance and mechanical properties.

The fiber woven material of the present woven material is not limited, and examples include twill woven materials and plain woven materials. Plain woven materials are generally used as an airbag base material from the perspective of productivity and thickness.

A method of manufacturing the present woven material is not limited. For example, the silicone rubber composition described above can be coated on the woven material by spraying, gravure coating, bar coating, knife coating, patting, screen printing, dipping, or other well-known method. At this time, a coating amount of the silicone rubber composition is generally within a range of 10 to 100 g/m². Furthermore, the silicone rubber composition can be coated and then heated for 1 to 2 minutes at 150 to 200° C. to cure the composition.

The present woven material may have one layer or multiple layers of a silicone rubber coating layer. Furthermore, the present woven material may have an arbitrary additional coating layer if necessary. The additional coating layer is generally a layer for improving the feel of a surface of the woven material, further improving abrasiveness of the surface, or improving the strength of the woven material. Specific examples include coating layers made from a plastic film, woven material, nonwoven material, and other elastic coating agents. Examples

The silicone rubber composition and the woven material coated with a silicone rubber of the present invention will be described in detail based on examples. Note that the viscosity (mPa·s) in the examples is a value at 25° C. measured using a rotational viscometer in accordance with JIS K7117-1, and the kinematic viscosity (mm²/s) is a value at 25° C. measured by a Ubbelohde viscometer in accordance with JIS Z8803. Furthermore, preparation of the woven material coated with a silicone rubber and evaluations thereof are as follows.

<Preparation of Woven Material Coated with Silicone Rubber>

A silicone rubber composition was coated onto one surface of a nylon 66 woven material containing filament yarn with a total fiber degree of 470 decitex and having a warp density of 46 threads/inch and a weft density of 46 threads/inch, such that the coating amount was within a range of approximately 13 to 16 g/m². Next, the silicone rubber composition was cured by heating for 70 seconds in a 190° C. oven to prepare the woven material coated with a silicone rubber.

<Flammability of Woven Material Coated with Silicone Rubber>

A rectangle having a length of 10 cm and width of 25 cm was cut out from the woven material coated with a silicone rubber prepared as described above, which was used as a test piece, and the flammability thereof was evaluated based on the burning rate. The burning rate (mm/min.) was measured in accordance with a method specified in flammability test FMVSS No. 302 (Federal Motor Vehicle Safety Standards No. 302) for automotive interior materials.

<Aperture Properties of Woven Material Coated with Silicone Rubber>

A rectangular test piece with a width of 50 mm and length of 100 mm was cut out from the woven material coated with a silicone rubber prepared as described above. The test piece was penetrated with a jig having comb tooth needles arranged at 4 mm intervals at 5 mm from an end of the 50 mm width test piece. The jig and other end of the test piece were set in a tensile testing machine, and pulled at a tensile rate of 200 mm/minute. The maximum tensile strength (N) for the test piece to be pulled out of the comb tooth needles arranged at equal intervals was measured. The aperture properties were measured based on the tensile strength, in other words, the edgecomb resistance (N).

<Preparation Example 1>

100 parts by mass of a dimethylpolysiloxane end-blocked with dimethylvinylsiloxy groups at both molecular chain terminals and having a viscosity of 40,000 mPa·s (a content of vinyl groups =approximately 0.09 mass %), 40 parts by mass of a fumed silica having a BET specific surface area of 225 m²/g, 7 parts by mass of hexamethyldisilazane, 2 parts by mass of water, and 0.2 parts by mass of a copolymer of dimethylsiloxane and methylvinylsiloxane end-blocked with dimethylhydroxysiloxy groups at both molecular chain terminals and having a viscosity of 20 mPa·s (a content of vinyl groups =approximately 10.9 mass %) were introduced into a Ross mixer and then mixed until uniform at room temperature. Thereafter, heat treatment was performed for 2 hrs. at 200° C. under reduced pressure to prepare a fluid silica masterbatch.

<Examples 1 to 6 and Comparative Examples 1 to 4>

The silicone rubber compositions were prepared by uniformly mixing the following components to achieve the compositions shown in Table 1. The properties of the obtained woven materials coated with a silicone rubber are shown in Table 1. Note that in the formulae, Me and Vi respectively represent a methyl group and vinyl group, and the molar ratio of silicon atom-bonded hydrogen atoms in component (C) with regard to the total amount of alkenyl groups in components (A) and (B) in the composition was 2.7.

The following component was used as component (A).
(a-1): a dimethylpolysiloxane end-blocked with dimethylvinylsiloxy groups at both molecular chain terminals and having a viscosity of 10,000 mPa·s (a content of vinyl groups: approximately 0.13 mass %)

The following component was used as component (B).
(b-1): an organopolysiloxane resin represented by the following average unit formula:

(Me₃SiO_{1/2})₀₄₀(ViMe₂SiO_{1/2})_{0.04}(SiO_{4/2})_{0.56}

(a content of vinyl groups=approximately 1.6 mass %)

The following component was used as component (C).
(c-1): an organopolysiloxane with a kinematic viscosity of 15 mm²/s and represented by the following average unit formula:

(Me₃SiO_{1/2})_{0.09}(Me₂SiO_{2/2})_{0.32}(HMeSiO_{2/2})_{0.54}(MeSiO_{3/2})_{0.05}

(a content of silicon atom-bonded hydrogen atoms=approximately 0.83 mass %)

The following component was used as component (D).
(d-1): 1,3-divinyltetramethyldisiloxane solution of a 1,3-divinyltetramethyldisiloxane complex of platinum (a content of platinum metals=approximately 4,000 ppm)

The following component was used as component (E).
(e-1): the silica masterbatch prepared in Preparation Example 1

The following components were used as component (F).
(f-1): a non-halogen intumescent flame retardant (ADK STAB FP-2100JC manufactured by ADEKA Corporation)
(f-2): a non-halogen intumescent flame retardant (ADK STAB FP-25005 manufactured by ADEKA Corporation)

The following component was used as a comparison of component (F).
(f-3): a non-halogen condensed phosphate ester flame retardant (ADK STAB FP-600 manufactured by ADEKA Corporation)

The following component was used as component (G).
(g-1): zirconium tetraacetylacetonate

The following component was used as component (H).
(h-1): 3-glycidoxypropyl trimethoxysilane

The following component was used as component (I).
(i-1): a silanol group-containing organosiloxane oligomer: a copolymer of dimethylsiloxane and methylvinylsiloxane end-blocked with dimethylhydroxysiloxy groups at both molecular chain terminals and having a viscosity of 20 mPa·s (a content of vinyl groups=approximately 10.9 mass %)

The following components were used as component (J).
(j-1): aluminum acetylacetonate
(j-2): alkylacetoacetate aluminum diisopropylate (Product name: PLENACT AL-M manufactured by Ajinomoto Fine-Techno Co., Ltd.)

The following component was used as component (K).
(k-1): an aluminum hydroxide powder having an average particle size of 1.0 μm (Product name: Hidilite H42M manufactured by Showa Denko K.K.)

The following component was used as a comparison of component (K).
(k-2): a magnesium hydroxide powder (MAGSEEDS S manufactured by Konoshima Chemical Co., Ltd.)

The following component was used as a curing inhibitor.
(l-1): 1-ethnylcyclohexan-1 -ol

TABLE 1

| | | Present Invention | | | | | |
|---|---|---|---|---|---|---|---|
| | | Example 1 | Example 2 | Example 3 | Example 4 | Example 5 | Example 6 |
| Composition of | (a-1) | 67 | 67 | 67 | 67 | 67 | 67 |
| silicone rubber | (b-1) | 60 | 60 | 60 | 60 | 60 | 60 |
| composition | (c-1) | 8.4 | 8.4 | 8.4 | 8.4 | 7.4 | 8.4 |
| (parts by mass) | (d-1) | 0.32 | 0.32 | 0.32 | 0.32 | 0.32 | 0.32 |
| | (e-1) | 60 | 60 | 60 | 60 | 60 | 60 |
| | (f-1) | 20 | 10 | 0 | 10 | 10 | 5 |
| | (f-2) | 0 | 0 | 20 | 0 | 0 | 0 |
| | (f-3) | 0 | 0 | 0 | 0 | 0 | 0 |
| | (g-1) | 1.6 | 1.6 | 1.6 | 1.6 | 1.6 | 1.6 |
| | (h-1) | 1.42 | 1.42 | 1.42 | 1.42 | 1.42 | 1.42 |
| | (i-1) | 0.36 | 0.36 | 0.36 | 0.36 | 0.36 | 0.36 |
| | (j-1) | 0 | 0 | 0 | 0 | 2 | 0 |
| | (j-2) | 0 | 0 | 0 | 0 | 0 | 2 |
| | (k-1) | 0 | 0 | 0 | 20 | 0 | 0 |
| | (k-2) | 0 | 0 | 0 | 0 | 0 | 0 |
| | (l-1) | 1 | 1 | 1 | 1 | 1 | 1 |

| | | | | | | |
|---|---|---|---|---|---|---|
| Flammability (mm/min.) | 24 | 61 | 36 | 44 | 22 | 29 |
| Edgecomb resistance (N) | | 139 | | 181 | | |

| | | Comparative Examples | | | |
|---|---|---|---|---|---|
| | | Comparative | Comparative | Comparative | Comparative |
| | | Example 1 | Example 2 | Example 3 | Example 4 |
| Composition of | (a-1) | 67 | 67 | 67 | 67 |
| silicone rubber | (b-1) | 60 | 60 | 60 | 60 |
| composition | (c-1) | 8.4 | 8.4 | 8.4 | 8.4 |
| (parts by mass) | (d-1) | 0.32 | 0.32 | 0.32 | 0.32 |
| | (e-1) | 60 | 60 | 60 | 60 |
| | (f-1) | 0 | 0 | 0 | 0 |
| | (f-2) | 0 | 0 | 0 | 0 |
| | (f-3) | 0 | 20 | 0 | 0 |
| | (g-1) | 1.6 | 1.6 | 1.6 | 1.6 |
| | (h-1) | 1.42 | 1.42 | 1.42 | 1.42 |
| | (i-1) | 0.36 | 0.36 | 0.36 | 0.36 |
| | (j-1) | 0 | 0 | 0 | 0 |
| | (j-2) | 0 | 0 | 0 | 0 |
| | (k-1) | 0 | 0 | 0 | 50 |
| | (k-2) | 0 | 0 | 50 | 0 |
| | (l-1) | 1 | 1 | 1 | 1 |

| | | | | |
|---|---|---|---|---|
| Flammability (mm/min.) | 107 | 112 | 109 | 152 |
| Edgecomb resistance (N) | 106 | | 199 | |

### INDUSTRIAL APPLICABILITY

The silicone rubber composition of the present invention can provide a woven material such as a base material for an airbag or the like with sufficient flame retardance even with a low coating amount, when the composition is coated on the woven, and it can suppress an aperture of the woven. Therefore, the silicone rubber composition is suitable as a coating agent for a woven material used in curtain shield airbags, driver airbags, front passenger airbags, side airbags, knee airbags, ITS head airbags, and other airbags, emergency ejection seats for an aircraft, inflatable rafts, and other applications. Furthermore, the woven material coated with a silicone rubber of the present invention is suitable as a base material such of a curtain shield airbag, emergency ejection seat for an aircraft, and the like.

1. A silicone rubber composition comprising:
(A) 100 parts by mass of a straight chain organopolysiloxane having at least two alkenyl groups in a molecule;
(B) 5 to 100 parts by mass of a resinous organopolysiloxane containing: SiO_{4/2} unit, R¹₂R²SiO_{1/2} unit and R¹₃SiO_{1/2} unit, wherein R¹ independently represents an alkyl group having 1 to 12 carbon atoms and R² represents an alkenyl group having 2 to 12 carbon atoms, and containing 0.1 to 5.0 mass % of the alkenyl groups;
(C) an organopolysiloxane having at least two silicon atom-bonded hydrogen atoms in a molecule, in an amount such that the silicon atom-bonded hydrogen atoms in this component are 0.5 to 10 mols per 1 mol of the alkenyl groups in components (A) and (B);
(D) a hydrosilylation reaction catalyst in an amount to promote curing of the composition;
(E) 0.1 to 50 parts by mass of a reinforcing silica fine powder; and
(F) 5 to 30 parts by mass of an intumescent flame retardant.

2. The silicone rubber composition according to claim 1, further comprising:
(G) an organic titanium compound and/or an organic zirconium compound, in an amount of from 0.01 to 10 parts by mass per 100 parts by mass of component (A).

3. The silicone rubber composition according to claim 1, further comprising:
(H) an alkoxysilane containing an epoxy group and/or an alkoxysilane containing a methacrylic group or an acrylic group, in an amount of from 0.01 to 10 parts by mass per 100 parts by mass of component (A).

4. The silicone rubber composition according to claim 1, further comprising:
(I) a silanol group-containing organosiloxane oligomer, in an amount of from 0.01 to 10 parts by mass per 100 parts by mass of component (A).

5. The silicone rubber composition according to claim 1, further comprising:
(J) an organic aluminum compound, in an amount of from 0.01 to 10 parts by mass per 100 parts by mass of component (A).

6. The silicone rubber composition according to claim 1, further comprising:
(K) an aluminum hydroxide powder, in an amount of from 5 to 50 parts by mass per 100 parts by mass of component (A).

7. ) The silicone rubber composition according to claim 1, suitable for coating a woven material.

8. A woven material coated with a silicone rubber, wherein the silicone rubber it-is produced by coating the silicone rubber composition according to claim 1 on a surface of a woven material, and then curing the silicone rubber composition.

9. The woven material coated with a silicone rubber according to claim 8, wherein the woven material is a base material for an airbag.
